(19) United States
(12) Patent Application Publication
(10) Pub. No.: US 2023/0297859 A1
(43) Pub. Date: Sep. 21, 2023

(54) METHOD AND APPARATUS FOR GENERATING MULTI-DRONE NETWORK COOPERATIVE OPERATION PLAN BASED ON REINFORCEMENT LEARNING

(71) Applicant: Electronics and Telecommunications Research Institute, Daejeon (KR)

(72) Inventor: Ui Hwan CHOI, Daejeon (KR)

(73) Assignee: Electronics and Telecommunications Research Institute, Daejeon (KR)

(21) Appl. No.: 17/964,536

(22) Filed: Oct. 12, 2022

(30) Foreign Application Priority Data
Mar. 18, 2022 (KR) 10-2022-0033925

(51) Int. Cl. G06N 5/04; G06N 3/08; G06N 7/00; G06K 9/62; B64C 39/02

(52) U.S. Cl. CPC G06N 5/043; G06N 5/042; G06N 3/08; G06N 7/005; G06K 9/6262; B64C 39/024; B64C 2201/141

(57) ABSTRACT

The present disclosure relates to a method and apparatus for generating a multi-drone network operation plan based on reinforcement learning. The method of generating a multi-drone network operation plan based on reinforcement learning includes defining a reinforcement learning hyperparameter and training an actor neural network for each drone agent by using a multi-agent deep deterministic policy gradient (MADDPG) algorithm based on the defined hyperparameter, generating Markov game formalization information based on multi-drone network task information and generating state-action history information by using the trained actor neural network based on the formalization information, and generating a multi-drone network operation plan based on the state-action history information.

### CROSS-REFERENCE TO RELATED APPLICATION

This application claims priority to and the benefit of Korean Patent Application No. 10-2022-0033925, filed on Mar. 18, 2022, the disclosure of which is incorporated herein by reference in its entirety.

### BACKGROUND

### 1. Technical Field

The present disclosure relates to a method and apparatus for generating a drone network operation plan based on reinforcement learning in relation to the execution of a multi-data sensing task by a plurality of drones (e.g., unmanned air vehicles (UAVs) or flying robots) connected over a network. The method and apparatus according to embodiments of the present disclosure are realized by using an observation and action model for multi-agent reinforcement learning, a multi-drone network communication cost and reward model, an operation plan generation algorithm based on a neural network (i.e., a neural operational planner).

### 2. Related Art

With the development of a drone fabrication technology and a flight control technology, high-performance observation/sensing mission equipment and communication apparatus have become mounted on a drone. If multiple drones on which such mission equipment has been mounted operate, low-cost and high-efficiency data sensing (or observation) for multiple task points is made possible. Furthermore, an operation range of a multi-drone system can be maximized by using the drone itself as a movable communication relay apparatus. However, it is difficult to formulate an effective drone operation plan capable of maximizing cooperative synergy between multiple drones on which various types of mission equipment have been mounted. In particular, in the case of drone communication, it is necessary to strictly consider communication distance restrictions to maintain a smooth communication link when an operation plan is formulated because communication distances between a base station and a drone and between drones are limited. Furthermore, in general, the drone operation plan requires experienced drone control persons and a lot of time for designing the drone operation plan.

That is, there is a high difficulty in formulating an operation plan for a multi-drone network, which performs a data sensing task and a communication relay task, due to a unique characteristic of drone having high mobility, strict communication restrictions, etc.

### SUMMARY

Various embodiments are directed to providing a method and apparatus for automatically generating a cooperative operation plan in a network between multiple drones in semi-real time by introducing an artificial intelligence (AI)-based algorithm that performs a cooperative task about data sensing and communication relay, in order to solve the aforementioned difficulty and to reduce an operation burden of drone control persons.

Objects of the present disclosure are not limited to the aforementioned object, and other objects not described above may be evidently understood by those skilled in the art from the following description.

In an embodiment, a method of generating a multi-drone network operation plan based on reinforcement learning includes steps of (a) defining a reinforcement learning hyperparameter and training an actor neural network for each drone agent by using a multi-agent deep deterministic policy gradient (MADDPG) algorithm based on the defined hyperparameter, (b) generating Markov game formalization information based on multi-drone network task information and generating state-action history information by using the trained actor neural network based on the formalization information, and (c) generating a multi-drone network operation plan based on the state-action history information.

In an embodiment of the present disclosure, the multi-drone network task information may include information on a base station, information on a target point, information on a drone agent, information on communication, and a task termination condition.

In an embodiment of the present disclosure, the step (b) may include steps of (b1) generating the formalization information based on the task information, (b2) initializing a state of each drone agent based on the formalization information, (b3) obtaining observation for each drone agent based on the initialized state of each drone agent, (b4) inferring an action of each drone agent by inputting the observation to the actor neural network, (b5) obtaining a next state of each drone agent based on the state and the action, and (b6) determining whether a task termination condition included in the task information has been satisfied based on the next state, repeating the steps (b3) to (b5) when the task termination condition is not satisfied, and generating the state-action history information by synthesizing the state and the action when the task termination condition is satisfied.

In an embodiment of the present disclosure, the state-action history information may include location information of a drone for each decision step. In this case, the step (c) may include generating flight path information of the drone included in the operation plan based on the location information.

In an embodiment of the present disclosure, the state-action history information may include a task time of a drone and location information of the drone for each decision step. In this case, the step (c) may include generating speed information of the drone included in the operation plan based on the task time and the location information.

In an embodiment of the present disclosure, the state-action history information may include network topology history information for each decision step. In this case, the step (c) may include generating topology information included in the operation plan based on the topology history information.

In an embodiment of the present disclosure, the state-action history information may include task intent of a drone and an action of the drone for each decision step. In this case, the step (c) may include generating task execution information included in the operation plan based on the task intent and the action of the drone.

Furthermore, in an embodiment, a multi-drone agent reinforcement learning method based on a multi-agent deep deterministic policy gradient (MADDPG) algorithm includes steps of (a) defining a reinforcement learning hyperparameter, (b) initializing a state of a Markov game and obtaining observation for each drone agent based on the initialized state of the Markov game, (c) generating tuple data comprising observation, an action, a reward, and next observation for each drone agent by using an MADDPG algorithm based on the defined hyperparameter and the state and storing the tuple data in a replay buffer, (d) extracting a mini-batch of the tuple data from the replay buffer through random sampling, and (e) updating an actor neural network for each drone agent based on the mini-batch.

In an embodiment of the present disclosure, the multi-drone agent reinforcement learning method may further include, after the step (e), a step of (f) increasing a repetition number by 1, determining whether the repetition number has reached a set upper limit, and repeating the steps (c) to (e) when the repetition number does not reach the set upper limit.

In an embodiment of the present disclosure, the multi-drone agent reinforcement learning method may further include, after the step (f), a step of (g) determining whether a given learning termination condition is satisfied, terminating the learning when the given learning termination condition is satisfied, and repeating the steps (b) to (f) when the given learning termination condition is not satisfied.

In an embodiment of the present disclosure, the step (c) may include obtaining the observation based on the state, inferring the action based on the observation, obtaining the reward and a next state of each drone agent based on the state and the action, and obtaining the next observation based on the next state.

In an embodiment of the present disclosure, the hyperparameter may include a parameter for the actor neural network. In this case, the step (c) may include inferring the action by using the actor neural network.

In an embodiment of the present disclosure, the hyperparameter may include a topology model and a communication cost model about a communication network of a multi-drone. In this case, the step (c) may include calculating a communication cost of the communication network by using the topology model and the communication cost model based on the state and the action and calculating the reward based on the state, the action, and the communication cost.

In an embodiment of the present disclosure, the initialized state may include a task time, a location vector for each drone agent, a multi-drone communication network topology, connectivity of a multi-drone communication network, and whether a task for each drone agent has been completed.

In an embodiment of the present disclosure, the observation may include a current task time, a location of a drone agent, current task intent of a drone agent, communication network connectivity of a multi-drone, relative location coordinates of a ground station, relative location coordinates of a target point, whether a drone agent has been completed a task, and relative location coordinates of another drone agent. The task intent may be any one of communication relay between other drone agents, the execution of a task by the drone agent, moving in a direction in which another drone agent is present, and moving in a direction toward the ground station.

In an embodiment of the present disclosure, the reward may be defined based on connectivity of a multi-drone communication network, a communication cost of the network, and whether a task for each drone agent has been completed.

In an embodiment of the present disclosure, the drone agent may have one piece of task intent every decision step. The action may correspond to any one of a simple moving direction decision action and an intent-explicit decision action. The simple moving direction decision action may be an action of determining only a moving direction without changing current task intent in a next decision step. The intent-explicit decision action may be an action of explicitly selecting task intent in a next decision step. The task intent may be any one of communication relay between other drone agents, the execution of a task by a drone agent, moving in a direction in which another drone agent is present, and moving in a direction toward a ground station.

Furthermore, in an embodiment, a multi-drone network operation plan generator based on reinforcement learning includes an input unit configured to receive a reinforcement learning hyperparameter and multi-drone network task information, a learning unit configured to train an actor neural network for each drone agent by using a multi-agent deep deterministic policy gradient (MADDPG) algorithm based on the reinforcement learning hyperparameter, and a plan generation unit configured to generate state-action history information by using the trained actor neural network based on the multi-drone network task information and generate a multi-drone network operation plan based on the state-action history information.

In an embodiment of the present disclosure, the learning unit may generate tuple data comprising observation, an action, a reward, and next observation for each drone agent by using the MADDPG algorithm based on the reinforcement learning hyperparameter, and may train the actor neural network for each drone agent based on a mini-batch of the tuple data.

In an embodiment of the present disclosure, the plan generation unit may initialize a state of each drone agent based on the task information, may obtain observation for each drone agent based on the initialized state, may infer an action of each drone agent by inputting the observation to the trained actor neural network, may change the state of each drone agent based on the state and the action, and may determine whether a task termination condition included in the task information is satisfied based on the state and generate the state-action history information by synthesizing histories of the state and the action when determining that the task termination condition is satisfied.

According to a conventional technology, when a drone operation plan is formulated, experienced control persons are involved or a complicated simulation/optimization tool is used. According to the embodiments of the present disclosure, however, there is an effect in that AI can autonomously learn a method of formulating a sub-optimal operation plan through a reinforcement learning scheme.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a diagram regarding a task outline of a multi-drone system according to embodiments of the present disclosure.

FIG. 2 is a block diagram illustrating a configuration of a task drone.

FIG. 3 is a diagram for describing task intent of a drone agent.

FIG. 4 is a flowchart for describing a method of generating a multi-drone network operation plan according to an embodiment of the present disclosure.

FIGS. 5A and 5B are flowcharts for describing a multi-drone agent reinforcement learning method based on a multi-agent deep deterministic policy gradient (MADDPG) algorithm according to an embodiment of the present disclosure.

FIG. 6 is a flowchart for describing a method of generating state-action history information according to an embodiment of the present disclosure.

FIG. 7 is a block diagram illustrating a configuration of a multi-drone network operation plan generator according to an embodiment of the present disclosure.

FIG. 8 is a block diagram illustrating a configuration of computer system to perform methods according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are provided to only complete the present disclosure and to fully notify a person having ordinary knowledge in the art to which the present disclosure pertains of the category of the present disclosure. The present disclosure is merely defined by the category of the claims. Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element.

In describing the present disclosure, a detailed description of a related known technology will be omitted if it is deemed to make the subject matter of the present disclosure unnecessarily vague.

Hereinafter, embodiments of the present disclosure are described in detail with reference to the accompanying drawings. In describing the present disclosure, in order to facilitate general understanding, the same reference numerals are used for the same means regardless of reference numerals.

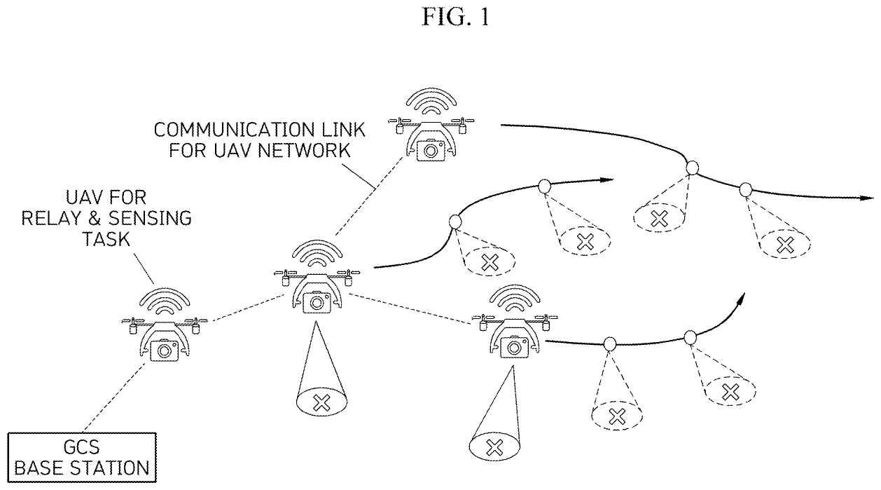

FIG. 1 is a diagram regarding a task outline of a multi-drone system, that is, a target to which the present disclosure is applied. M “target points” are randomly distributed in a wide-range task area that is difficult for a single drone to handle. Each of the target points may be a drone image photographing point, such as electro-optical/infrared (EO/IR) or may be a data sensing target point that requires a special sensor for measuring an atmosphere pollution matter, etc. In order to effectively finish data sensing for the M target points within limited drone flight duration, a plurality of (N) task drones may be introduced. Each of the drones senses data for the target point, communicates with a ground control station (GCS) over a UAV network, or performs a communication relay task between drones.

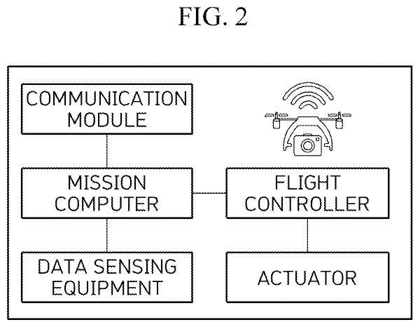

FIG. 2 is a block diagram illustrating a configuration of a task drone that performs a task in the aforementioned multi-drone system. The task drone has a mission computer additionally mounted thereon in addition to a flight controller for a drone and an actuator. The mission computer may be connected to major mission equipment, such as a “communication module” and “data sensing equipment.” The communication module means a communication modem, a router, an access point (AP), etc. which may be mounted on the drone in an on-board way, and is used to enable aerial relay by constructing a communication link (i.e., an air-to-ground link) between a drone itself and the GCS and a communication link (i.e., an air-to-air link) between drones. The data sensing equipment is on-board mission equipment which enables data sensing for target points, and may include pieces of mission equipment used in various drone task forms, such as a drone-mounted camera, a thermal image camera, and a fine dust measurement sensor.

The N task drones need to cooperate with each other to perform data sensing on the M target points. In order to perform the data sensing on more target points as soon as possible, the N task drones have a primary task goal of performing data sensing for different target points while dispersing.

Furthermore, all the task drones have a secondary task goal of transmitting data sensed by the drones to a ground station in real time while maintaining communication with the GCS (or a ground base station). However, a maximum-communicatable distance of each of the task drones is restricted due to performance limitation of a communication module mounted on each task drone. All the drones need to maintain a communication link with the ground station. In general, a communication distance of the communication link (i.e., the air-to-ground link) between the drone and the ground station is shorter than a communication distance of the communication link (i.e., the air-to-air link) between drones. The drones each having a communication relay function construct an aerial ad-hoc network, and all the dispersing drones cooperate to be connected with each other over one network. Each drone needs to extend its area in which a task can be performed while maintaining the communication link.

If communication relay and a data sensing cooperative task of multiple drones belonging to the aforementioned multi-drone system are optimized, calculation complexity is increased due to communicatable distance restrictions of the drone, the variability of an ad-hoc network topology, the mobility of the drone, etc. Accordingly, if an operation plan solution is derived through the existing scheme, an excessive operation time may be required. The present disclosure presents a method and apparatus capable of generating a sub-optimal operation plan for such a complicated multi-drone cooperative task in real time by applying a multi-agent reinforcement learning scheme through a deep neural network.

In order to generate an operation plan for a multi-drone cooperative task by applying the reinforcement learning scheme, first, there is a need for a process of formulating the present task situation as a multi-agent Markov game. The Markov game has a form in which a Markov decision process (MDP), that is, a sequential decision problem, has been expanded to a multi-agent decision problem. In the Markov game, each of N agents recognizes the entire system state as local observation and performs a local action based on a distributed local policy of each agent.

### Task Execution Intent

With respect to a communication relay and data sensing cooperative task situation of a multi-drone network, in order to effectively train an agent through reinforcement learning, it is very important to define an observation model, an action model, and a reward model suitably for the situation. The present disclosure is intended to derive smooth learning by defining a concept called a “task intent (TI)” assigned to each drone agent (in the present disclosure, a “drone agent” may be abbreviated as a “drone”) in relation to the action model.

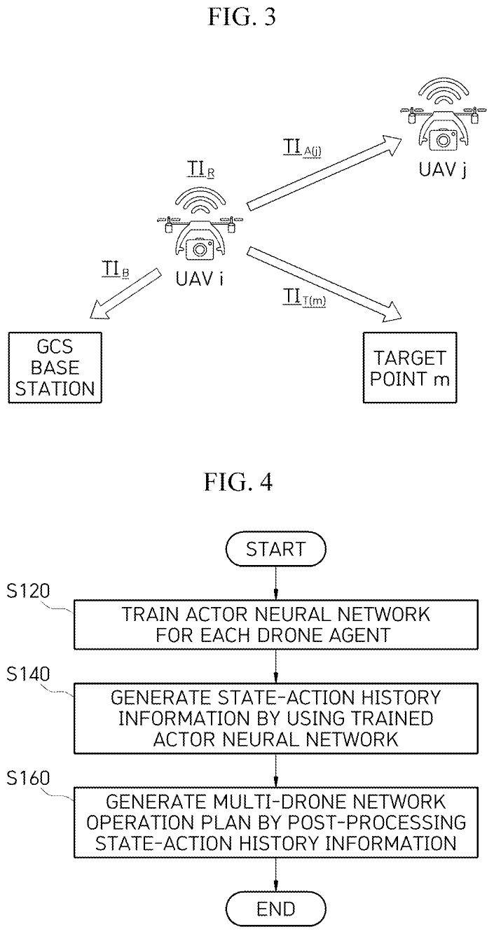

FIG. 3 is a diagram for describing task intent of a drone agent. As illustrated in FIG. 3, each drone agent has one of the following pieces of task intent every decision step. The drone agent may maintain previous task intent without changing the previous task intent or may select the same or different task intent every decision step.
\textcircled{1} TI_{R}: prioritizes a communication relay task at a current location
\textcircled{2} TI_{T}(m): prioritizes a data sensing task for a specific m-th target point
\textcircled{3} TI_{A}(j): prioritizes moving in a direction in which another drone agent UAV(j) is present
\textcircled{4} TI_{B}: prioritizes moving/returning in the direction toward the ground station

The present disclosure has defined the observation model, the action model, and the reward model, that is, components of the Markov game suitably for a multi-drone network situation based on the definition of the “task intent.”

### State

Prior to the definition of the observation model, a state of the Markov game needs to be defined. In order to formulate a communication relay-data sensing cooperative task of a multi-drone network into the Markov game problem, locations of multiple drones, a drone communication state, the entire task progress situation, etc. are synthetically defined as a “state.” A state (s) of the Markov game handled in the formalization may be represented as follows.

s=<t, {pᵢ}, c, η, {δₘ}, {τᵢ}>

wherein t is a task time, {pᵢ}(i=1, . . . , N) is a set (pᵢ=[p_{x,i}, p_{y,i}]) of horizontal location coordinate vectors of each drone, c is communication network topology information (e.g., a tree structure, a serial structure, a mesh network, etc.) of multiple drones, η is connectivity information (0 when communication is smooth, and 1 when there is a communication disconnection danger) of a drone communication network, {δₘ} (m=1, . . . , M) is a set of flags indicating whether data sensing for each target point (or data sensing point) has been completed (0: not completed, 1: completed), and {Tᵢ} is a set of pieces of task intent of drone agents.

The communication network topology information (c) of multiple drones is determined based on a topology model, but may be dynamically changed based on the topology model by taking locations of a plurality of drones and a base station into consideration every step.

### Observation Model

Each of drone agents observes the aforementioned state (s) within a frame of the Markov game from its position. The drone agents dispersively perform independent decisions on the basis of such local observation.

For smooth multi-agent reinforcement learning, the observation model (oᵢ: S→O), that is, state information which may be observed by an i-th drone agent (hereinafter abbreviated as a UAV(i)) is defined as follows.
\textcircled{1} Observation for itself: a current task time (t), its own location (pᵢ), and its own current task intent (τᵢ)
\textcircled{2} Observation obtained from the ground station: communication connectivity (η) of the entire drone network, relative location coordinates (p_{GCS}-pᵢ) of the ground station GCS which are calculated on the basis of its own location coordinates, a relative distance from the ground station, relative location coordinates (p_{TG,m}-pᵢ) of target points (TG) (m=1, . . . , M), and whether data sensing for each target point has been completed ({δₘ})
\textcircled{3} Observation for another drone which is obtained through communication with another drone: relative location coordinates (pⱼ-pᵢ) of another drone agent (j) and a relative distance from another drone agent (j), which are calculated on the basis of its own location coordinates.

For reference, a relative distance may be calculated on the basis of relative location coordinates between the ground station and another drone. In the present disclosure, however, in order to increase learning efficiency of a neural network assigned to each drone agent, a relative distance is also included in the observation model (or observation information) along with relative location coordinates.

### Action Model

The action model Aᵢ of a drone agent UAV(i) includes a simple moving direction decision action (a_{GoTo}) that does not specify specific task intent and an intent-explicit decision action (a_{τ}) that explicitly selects task intent to be adopted in a next decision. Each drone agent selects one of such actions every decision step. The following is an equation representation of the action model (Aᵢ).

Aᵢ={{a_{GoTo}}∪{a_{τ}}}

{a_{GoTo}}={a_{stay}, a₊ₓ, a₋ₓ, a_{+y}, a_{-y}}

{a_{τ}}={a_{relay}, a_{toTg1}, . . . , a_{toTgM}, a_{toUAV (1)}, . . . , a_{toUAV (N)}, a_{toBase}}

In the case of the simple moving direction decision action a_{GoTo}), each drone agent performs a simple movement in a square grid form in an x axis or y axis direction without changing its own current task intent. In the case of the intent-explicit decision action (a_{τ}), each drone agent explicitly selects its own next task intent, and performs a movement suitable for the corresponding task intent. Table 1 is related to the task intent (τᵢ) and a movement method according to the intent-explicit decision action (a_{τ}).

TABLE 1

| Intent-explicit | | |
|---|---|---|
| decision action | Next task | |
| (a_{τ}) | intent (τᵢ) | Movement method |
| a_{relay} | TI_{R} | hovering at a current |
| | | location |
| a_{toTg(m)} | TI_{T(m)} | Move in the direction of |
| | | an m-th target point |
| a_{toUAV(j)} | TI_{A(j)} | Move in the direction of |
| | | the UAV(j) |
| a_{toBase} | TI_{B} | Move in the direction |
| | | toward the ground station |

### Reward Model

The reward model (rᵢ: S×Aᵢ→R) of a drone agent UAV(i) may be defined like Equation 1. Basically, the shorter the entire task end time is, the higher each drone agent obtains, and each drone agent is given a penalty depending on a state of a communication network.

$${r}_{i} = \{ \begin{matrix}\begin{matrix}T - {k}_{f , i} & ( if k = {k}_{f , i} )\end{matrix} \\ \begin{matrix}{n}_{k} ( T - k ) - ( ( 1 - η ) {ϵ}_{r} {J}_{comm} + η ) & ( if k < {k}_{f , i} )\end{matrix}\end{matrix} \qquad [ Equation 1 ]$$

In Equation 1, T is a maximum decision step, k is a current decision step, k_{f,i} is a step in which a drone agent UAV(i) performs all tasks and returns to the base station, and nₖ is 5 the number of target points for which data sensing has been terminated by all of multiple drones in a current step (k). For example, in a step k=10, if drone agents UAV(2) and UAV(3) have simultaneously terminated data sensing for target points TG(4) and TG(8), respectively, n₁₀ becomes 2. η indicates current network communication connectivity (smooth when η is 0, and dangerous when η is 1), that is, one of the elements of the observation model. Furthermore, ϵᵣJ_{comm}(<1) is a penalty term into which overall communication performance of an ad-hoc communication network has been incorporated. In this case, J_{comm} is a communication cost of a multi-drone network, and ϵᵣ is a communication penalty normalization coefficient. ϵᵣ has been designed so that an absolute value of accumulation amount of the penalty term (ϵᵣJ_{comm}) attributable to the communication cost is less than 1 for the stabilization of the reinforcement learning process.

According to the reward model, the shorter a step of succeeding in a data sensing task for all of the M target points and a step of terminating all tasks including a return to the base becomes, the greater reward each drone agent obtains. However, if an inefficient ad-hoc network is generated or a communication link is disconnected due to relative locations between all of multiple drones and the ground station in a current step (k), the drones are given a penalty. In Equation 1, the penalty is 1 when there is a communication disconnection danger (η=1), and when communication is smooth (η=0), the penalty is determined based on a communication cost and is a value less than 1.

The communication cost J_{comm} of a multi-drone network is calculated by combining a existing communication network topology model and a existing communication cost model. The communication penalty normalization coefficient ϵᵣ is designed so that for stabilization in the reinforcement learning process, an accumulation value of a communication penalty (a penalty accumulation value from the first step (k=0) to a maximum decision step (k=T)) is not greater than 1. The reason why a criterion for the end step of the penalty accumulation is based on the maximum decision step (k=T) instead of a task end time (k=k_{f,i}) is for the stability of learning. The reason for this is that if a penalty accumulation value until the task end time is used for learning, the task end time continues to change during the learning process, which makes the learning process unstable.

If a maximum value (J_{comm,max}) of the communication cost J_{comm} that is technically/theoretically possible is known, ϵᵣ=1/(J_{comm,max}* (T+1)) may be applied. The following existing models may be taken into consideration as a model capable of calculating the multi-drone network communication cost J_{comm}. In the present disclosure, a communication network topology model and a communication cost model for calculating a multi-drone network communication cost are not particularly limited.
A multi-drone communication network cost model: global message connectivity (GMC)
A communication network topology: a minimum spanning tree
A communication environment model: a free propagation model, a concentrated city center model, etc.

A method of generating a multi-drone network operation plan and a multi-drone network operation plan generator according to embodiments of the present disclosure automatically generate a plan capable of completing data sensing for a target point within the shortest time, while maintaining smooth communication in a drone network, by applying the aforementioned task intent, a state of the Markov game, the observation model (oᵢ), the action model (Aᵢ), and the reward model (rᵢ) while being based on the reinforcement learning algorithm (or the multi-agent deep deterministic policy gradient (MADDPG)).

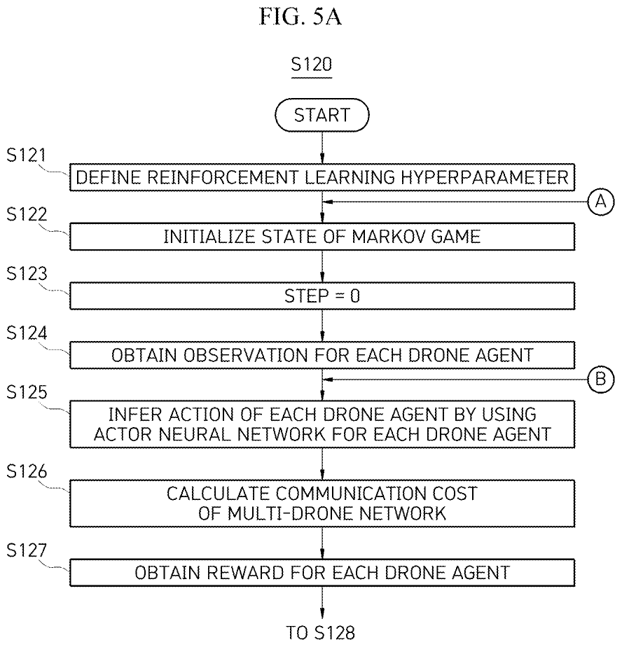

FIG. 4 is a flowchart for describing a method of generating a multi-drone network operation plan according to an embodiment of the present disclosure.

The method of generating a multi-drone network operation plan according to an embodiment of the present disclosure includes step S120, step S140, and step S160, and may be performed by a multi-drone network operation plan generator 200. Step S120 is a step of training, by the multi-drone network operation plan generator 200, an actor neural network for each drone agent. Step S140 is a step of generating, by the multi-drone network operation plan generator 200, state-action history information by using the trained actor neural network. Step S160 is a step of generating, by the multi-drone network operation plan generator 200, a multi-drone network operation plan by post-processing the state-action history information. If a multi-drone network operation plan is generated by using the trained actor neural network again, only step S140 and step S160 of the aforementioned steps are performed. Contents performed by each of the steps are described in detail below.

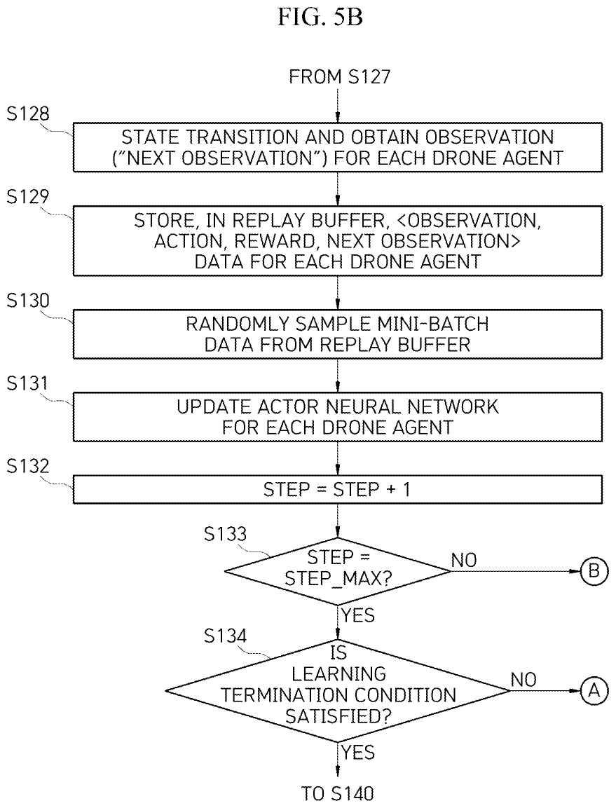

Step S120 is the step of training, by the multi-drone network operation plan generator 200, an actor neural network for each drone agent, that is, a model which infers an action of the drone agent belonging to a multi-drone network, by using the reinforcement learning scheme. This step is described in detail with reference to FIGS. 5A and 5B.

FIGS. 5A and 5B are flowcharts for describing a multi-drone agent reinforcement learning method based on the multi-agent deep deterministic policy gradient (MADDPG) algorithm according to an embodiment of the present disclosure. The multi-drone agent reinforcement learning method corresponds to step S120 of the method of generating a multi-drone network operation plan according to an embodiment of the present disclosure. In order to implement a multi-drone network situation, various reinforcement learning algorithms may be applied. In the present disclosure, a multi-drone agent learning method based on the MADDPG algorithm is exemplified. The MADDPG algorithm is one of reinforcement learning algorithms which may be applied to a multi-agent decision problem formulated as the Markov game, and has been designed based on a centralized training and decentralized execution (CTDE) framework.

The multi-drone agent learning method based on the MADDPG algorithm according to an embodiment of the present disclosure includes step S121 to step S133.

Step S121 is a step of defining a reinforcement learning hyperparameter. The multi-drone network operation plan generator 200 receives a set value for the hyperparameter through an input unit 210. The input unit 210 delivers the received hyperparameter set value to a learning unit 220. The input unit 210 may store the hyperparameter set value in a memory 240.

The hyperparameter includes the number of drone agents belonging to a multi-drone network, the number of target points, drone parameters (e.g., a maximum speed of a drone, a drone flight altitude, and a sensing distance of drone mission equipment), and communication parameters (e.g., a multi-drone network communication cost model, a maximum-communicatable distance between two drones, a maximum-communicatable distance between a drone and a base station, and a topology model), in addition to a learning repetition number (e.g., the upper limit of a decision step) and a learning termination condition (e.g., a maximum repetition number or maximum operation time of an algorithm) after the initialization of a state of the Markov game. In this case, the “topology model” included in the communication parameter is configured before a communication topology model to be used for learning is trained, and includes a serial structure, a mesh structure, and a tree structure, for example.

Furthermore, the hyperparameter includes the definition of a neural network of each drone agent. The neural network of each drone agent includes an actor neural network, and may further include a critic neural network and a target neural network for each actor and critic neural network by the nature of the MADDPG algorithm. The parameter for the neural network may include the number of input nodes, the number of output nodes, the number of hidden layers, the number of nodes of each hidden layer, and a connection structure between nodes.

Step S122 is a step of initializing a state of the Markov game based on the defined hyperparameter. The learning unit 220 of the multi-drone network operation plan generator 200 initializes a state of the Markov game based on the hyperparameter inputted in step S121. The “initialization of the state of the Markov game” means that state information s=<t, {pᵢ}, c, η, {δₘ}, {τᵢ}> of the Markov game constructed as in the aforementioned contents is initialized. For example, in this step, the learning unit 220 initializes whether data sensing for all target points (or data sensing points) has been completed (δₘ) to 0 (not completed).

Step S123 is a step of initializing a decision step. “STEP” in FIG. 5(FIG. 5A and FIG. 5B) means a decision step. The learning unit 220 initializes the decision step (STEP) to 0 so that the neural network of each drone agent is updated as many as a set repetition number (i.e., the upper limit of the decision step).

Step S124 is a step of obtaining observation for each drone agent based on the state of the Markov game. Each drone agent observes the state (s) within a frame of the Markov game from its own position. That is, the learning unit 220 generates observation information of each drone agent based on the state (s) of the Markov game.

Step S125 is a step of inferring an action of each drone agent by using an actor neural network assigned to each drone agent. The learning unit 220 infers an action of each drone agent by inputting the observation information to the actor neural network. In this process, random sampling through Gumbel-softmax may be applied. The Gumbel-softmax is a scheme used for the balance of exploration and exploitation in a reinforcement learning process. In the present disclosure, the Gumbel-softmax is used to randomly select an action of each drone agent. However, the random sampling for the action is used only during reinforcement learning (step S120). In the process (step S140 and step S160) of generating an operation plan by using the actor neural network after learning is terminated, random sampling for an action of each drone agent is not performed. As described above in relation to the action model, each drone agent selects any one action among actions belonging to a simple moving direction decision action (a_{GoTo}) and an intent-explicit decision action (a_{τ}) based on the results of the inference of the actor neural network. That is, the learning unit 220 generates action information by using the actor neural network based on the observation information.

Step S126 is a step of calculating a communication cost of a multi-drone network by using the multi-drone network communication cost model. The learning unit 220 calculates a communication cost of a multi-drone network by using a communication network topology model and a communication cost model based on the current state (s) and the action information (aᵢ) generated in step S125.

Step S127 is a step of obtaining a reward for each drone agent. The learning unit 220 may determine whether data sensing of each drone agent has been completed and the connectivity of a drone communication network (i.e., a communication network state) based on the current state (s) and the action information (aᵢ) generated in step S125. The learning unit 220 may calculate a reward for each drone agent by applying the aforementioned reward model, based on whether data sensing of each drone agent has been completed, the connectivity of the drone communication network, and the communication cost calculated in step S126.

Step S128 is a state transition and a step of obtaining observation. The learning unit 220 changes a state of each drone agent from the current state (s) to a next state (s′) based on the action information (aᵢ) for each drone agent generated in step S125. That is, the learning unit 220 obtains the state (s′) information for each drone agent in a next step based on the current state (s) and the action information (aᵢ) for each drone agent. Furthermore, the learning unit 220 generates (or obtains) observation information (i.e., next observation oᵢ′) of each drone agent based on the updated state (i.e., the state (s′) of the Markov game) for each drone agent.

Step S129 is a step of storing, in a replay buffer, <observation, action, reward, next observation> data for each drone agent. The learning unit 220 generates tuple data comprising observation, an action, a reward, and next observation for each drone agent and stores the tuple data in a replay buffer. In this case, observation data obtained in a previous step S128 becomes “next observation” data, and previously observed data becomes “observation” data. The replay buffer may be disposed in an internal repository of the learning unit 220 itself, and may be disposed in the memory 240.

Step S130 is a step of extracting mini-batch data from the replay buffer through random sampling. The learning unit 220 extracts a mini-batch of the tuple data from the replay buffer through random sampling. The mini-batch data is used for the learning unit 220 to train a neural network for each drone agent.

Step S131 is a step of updating the actor neural network for each drone agent. The learning unit 220 calculates a policy gradient for a mini-batch with respect to each drone agent and updates the actor neural network. Furthermore, for example, the learning unit 220 may first update a critic neural network in a way to minimize a loss function based on a mini-batch randomly sampled according to a basic algorithm of the MADDPG, and may then calculate a policy gradient for the mini-batch and update the actor neural network.

step S132 is a step of changing the decision step to a next step. That is, the learning unit 220 increases, by 1, a “STEP” value indicative of a decision step.

Step S133 is a step of determining whether the decision step has reached a set upper limit. The learning unit 220 determines whether the decision step has reached the set upper limit (or a repetition number “STEP_MAX”), performs step S134 when the decision step has reached the set upper limit, and performs step S125 (infers an action of each drone agent) when the decision step has not reached the set upper limit.

Step S134 is a step of determining whether a learning termination condition has been satisfied. The learning unit 220 determines whether a preset learning termination condition (e.g., a maximum repetition number or maximum operation time of the algorithm) has been satisfied, and terminates learning when the preset learning termination condition is satisfied. That is, the learning unit 220 finalizes an actor neural network for each drone agent, which has been finally updated, as an actor neural network (a “trained actor neural network”) to be used to generate state-action history information in step S140. When it is determined that the preset learning termination condition has not been satisfied, the learning unit 220 performs step S122 (i.e., the initialization of a state of the Markov game).

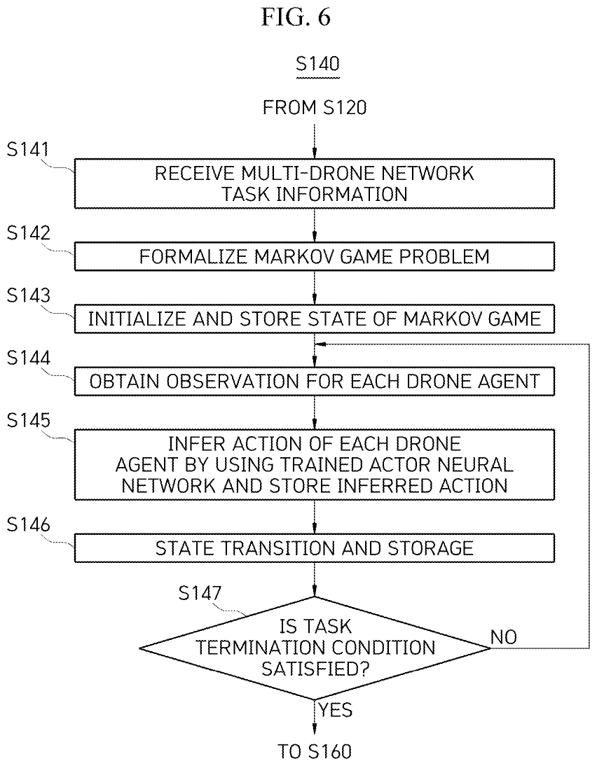

Referring back to FIG. 4, step S140 is described. Step S140 is a step of generating, by the multi-drone network operation plan generator 200, the state-action history information necessary to generate a multi-drone network operation plan by using the actor neural network trained in step S120. This step is described in detail with reference to FIG. 6.

FIG. 6 is a flowchart for describing a method of generating state-action history information according to an embodiment of the present disclosure. The method of generating state-action history information corresponds to step S140 of the method of generating a multi-drone network operation plan according to an embodiment of the present disclosure. The method of generating state-action history information according to an embodiment of the present disclosure includes step S141 to step S147.

Step S141 is a step of receiving multi-drone network task information. The multi-drone network operation plan generator 200 receives the multi-drone network task information through the input unit 210. The input unit 210 delivers the received task information to a plan generation unit 230. The input unit 210 may store the task information in the memory 240.

The “multi-drone network task information”, that is, an initial input and setting of the present embodiment, includes the following items.
\textcircled{1} Information on a base station and a target point: a location of a base station and the number and locations (or distribution) of target points
\textcircled{2} Information on a drone: the number of multiple drones and a location of each drone, and drone parameters (e.g., a maximum speed of a drone, a drone flight altitude, and a drone mission equipment sensing distance)
\textcircled{3} Information on communication: a multi-drone network communication cost model (e.g., (J_{comm}) and communication parameters (e.g., a maximum-communicatable distance between drones and a maximum-communicatable distance between a drone and a base station)
\textcircled{4} A task termination condition (e.g., a return after the completion of data sensing for all target points or the completion of data sensing)

Step S142 is a step of formalizing a Markov game problem. The plan generation unit 230 generates Markov game formalization information based on task information. That is, the plan generation unit 230 converts the task information into Markov game formalization information (e.g., a state of the Markov game, the observation model, the action model, and the reward model). Through the conversion, the state of the Markov game, the observation model, the action model, and the reward model are defined. The plan generation unit 230 may store the Markov game formalization information in an internal repository of the plan generation unit 230 or the memory 240.

Step S143 is a step of initializing and storing the state of the Markov game. The “initialization of the state of the Markov game” means that information state s=<t, {pᵢ}, c, η, {δₘ}, {τᵢ}> of the Markov game defined as in the aforementioned contents is initialized. For example, the plan generation unit 230 initializes whether data sensing for all target points (or data sensing points) has been completed (δₘ) to 0 (not completed). Furthermore, the plan generation unit 230 stores an initial state (s[0]) of the Markov game in an internal repository of the plan generation unit 230 or the memory 240.

Step S144 is a step of obtaining observation for each drone agent. Each drone agent observes a state (s[k]) in a current step within a frame of the Markov game from its own position. That is, the plan generation unit 230 generates observation information of each drone agent based on the state (s[k]) of the Markov game. The plan generation unit 230 may store the observation information in an internal repository thereof or the memory 240.

Step S145 is a step of inferring an action of each drone agent by using the trained actor neural network and storing the inferred action. Each drone agent infers its action by inputting the observation information to an actor neural network. That is, the plan generation unit 230 infers an action of each drone agent by using an actor neural network assigned to each drone agent based on the observation information, integrates the results of the inference (a[k]), and stores the integrated results in an internal repository of the plan generation unit 230 or the memory 240 by matching the integrated results with the state (s[k]) in the current step (k). That is, a state-action pair is stored in the internal repository or the memory 240 for each decision step.

Step S146 is a state transition and storage step. The plan generation unit 230 changes the state (s[k]) in the current step to a next state (s[k+1]) by using a known multi-drone network state transition model (e.g., a drone movement model) based on the inferred action of each drone agent. That is, the plan generation unit 230 obtains state (s′) information for each drone agent in a next step based on a current state (s) and an action (aᵢ) of each drone agent. For example, the plan generation unit 230 changes a location (pᵢ[k]) of an i-th drone in the current state to a next location (pᵢ[k+1]) of the i-th drone based on an action (aᵢ[k]) of the i-th drone by using the drone movement model (pᵢ[k], aᵢ[k] ->pᵢ[k+1]). Furthermore, the plan generation unit 230 stores the changed state (s[k+1]) in an internal repository of the plan generation unit 230 or the memory 240.

Step S147 is a step of determining whether a task termination condition has been satisfied. The plan generation unit 230 determines whether a preset task termination condition (e.g., data sensing completion for all target points) has been satisfied based on the changed state (i.e., a next state s[k+1]). When the task termination condition is satisfied, the plan generation unit 230 substitutes a current step (k) into a parameter in a maximum decision step (T), and terminates the storage of a state-action pair for each decision step. The plan generation unit 230 generates state-action history information by combining state-action pairs for each decision step from an initial state and action (s[0], a[0]) to a state and action (s[T], a[T]) in the maximum decision step (T). In this case, a[k] is a set of actions for each agent in {aᵢ[k]}, that is, a k step. When the task termination condition has not yet been satisfied, the plan generation unit 230 increases the current step by 1 and proceeds to step S144. Thereafter, in step S144, the plan generation unit 230 obtains observation for each drone agent on the basis of the state s[k+1] by using k+1 as a current step.

Referring back to FIG. 4, step S160 is described in detail below. Step S160 is a step of generating, by the multi-drone network operation plan generator 200, a multi-drone network operation plan by post-processing the state-action history information. As described above, the state-action history information consists of a set of state-action pairs for each decision step ({s[0], a[0], s[1], a[1], . . . , s[T], a[T]}). In the present embodiment, the multi-drone network operation plan may include the following information of \textcircled{1} to \textcircled{4}.
\textcircled{1} Location information (flight path information)/speed information for each drone according to a decision step
\textcircled{2} A task execution state (e.g., communication relay, data sensing or a movement) according to a decision step for each drone
\textcircled{3} A network topology (e.g., a drone-drone link or a drone-base station link) according to a decision step
\textcircled{4} A data sensing completion and base station return step

A process of generating, by the plan generation unit 230, information included in a multi-drone network operation plan based on state-action history information is described.

The following illustrates state-action history information from a step k=0 to a step k=T.

s[0]=<0, {pᵢ[0]}, c[0], η[0], {δₘ[0]}, {τᵢ[0]}>, a[0]={aᵢ[0]}

s[1]=<≢t, {pᵢ[1]}, c[1], η[1], {δₘ[1]}, {τᵢ[1]}>, a[1]={aᵢ[1]}

. . . .

s[k]=<kΔt, {pᵢ[k]}, c[k], η[k], {δₘ[k]}, {τᵢ[k]}>, a[k]={aᵢ[k]}

. . . .

s[T]=<TΔt, {pᵢ[T]}, c[T], η[T], {δₘ[T]}, {τᵢ[T]}>, a[T]={aᵢ[T]}

The plan generation unit 230 generates information included in a multi-drone network operation plan by reassembling state-action history information for each element according to a decision step. For example, the plan generation unit 230 may generate location information (\textcircled{1}) according to a decision step for each drone by synthesizing horizontal location coordinate vectors (pᵢ) of drones included in state history information according to a decision step, and may generate speed information (\textcircled{1}) based on a time difference (Δt) between decision steps and a horizontal location coordinate vector (pᵢ) of a drone. Furthermore, the plan generation unit 230 may generate task execution state (e.g., communication relay, data sensing or a movement) information (\textcircled{2}) according to a decision step for each drone by synthesizing task intent for each drone included in state history information of a drone and an action for each drone included in action history information. Furthermore, the plan generation unit 230 may generate network topology (e.g., a drone-drone link or a drone-base station link) information (\textcircled{3}) according to a decision step by synthesizing topology histories (c[0], . . . , c[T]) included in state history information of a drone. The drone network topology is dynamically changed. The network topology information (\textcircled{3}) is used to upload a role (e.g., a recipient/sender/bridge) of each drone and data reception/transmission node information for each decision step. Each drone can minimize communication delay by sequentially setting information on reception/transmission targets in a current step, reception/transmission targets in a next step, and reception/transmission targets in a second-next step based on the network topology information (\textcircled{3}) and previously uploading the information. Furthermore, the network topology information (\textcircled{3}) is closely associated with a wireless communication data bit rate and bandwidth restrictions.

Furthermore, the plan generation unit 230 may generate data sensing completion step and base station return step information (\textcircled{4}) based on information (δₘ) on whether data sensing of state history information has been completed. For example, the plan generation unit 230 may calculate a data sensing step for each target based on information (δₘ[k]) on whether data sensing for each decision step has been completed. A data sensing step for an m-th target may be represented like Equation 2.

Σₖ(Δt(1−δₘ[k])) [Equation 2]

Data sensing step information for the m-th target becomes basis information that is used to determine whether a drone has operated (on/off) data sensing equipment and a configuration (e.g., picture quality or a photographing mode (a thermal image/infrared rays)) of data sensing equipment upon image capturing. The information may be uploaded to the drone before a task starts. Furthermore, the information may be information for which reference may be made when the GCS displays data for a target on an operation/control monitoring screen.

The plan generation unit 230 may distribute, to each drone agent, a task plan derived from a multi-drone network operation plan only when a given criterion is satisfied by verifying the validity of the multi-drone network operation plan from a viewpoint of communication quality of the multi-drone network operation plan. That is, before uploading, to each drone, the final task plan derived from the multi-drone network operation plan, the plan generation unit 230 may verify the validity of the multi-drone network operation plan in terms of communication quality thereof, may perform the learning of a multi-drone agent again by adjusting a part of a hyperparameter when the validity does not comply with a given condition or may generate state-action history information again by modifying multi-drone network task information, and may then modify the multi-drone network operation plan. As a method of verifying the validity of the multi-drone network operation plan in terms of communication quality thereof, a method of checking a communication connectivity history may be used. For example, the plan generation unit 230 derives a communication connectivity history (η[0], . . . , η[T]) by reassembling state-action history information, verifies whether communication connectivity is maintained (η[k]=0) most of the time (e.g., 99%) in all steps (k=0 to k=T), and uploads, to each drone agent, the final task plan for each drone agent, which has been derived from a multi-drone network operation plan, when a criterion is satisfied. The communication connectivity history is not included in the multi-drone network operation plan or a task plan itself, but has a meaning as data for verifying communication quality of a task plan.

As described above, the plan generation unit 230 may generate a multi-drone network operation plan based on information extracted from state-action history information, and may store the multi-drone network operation plan in an internal repository of the plan generation unit 230 or the memory 240.

The multi-drone network operation plan generator 200 may upload a task plan for each drone agent, which has been generated by the plan generation unit 230 based on a multi-drone network operation plan, to the mission computer embedded in each drone agent so that the drone can actually use the multi-drone network operation plan.

In the description given with reference to FIGS. 4 to 6, each step may be subdivided into additional steps or assembled into smaller steps depending on an implementation example of the present disclosure. Furthermore, some steps may be omitted, if necessary, and the sequence of steps may be changed. Furthermore, although contents are omitted, the contents described with reference to FIGS. 1 to 3 and 7 may be applied to the contents described with reference to FIGS. 4 to 6. Furthermore, the contents described with reference to FIGS. 4 to 6 may be applied to the contents described with reference to FIGS. 1 to 3 and 7.

The method of generating a multi-drone network operation plan, the multi-drone agent reinforcement learning method based on an MADDPG algorithm, and the method of generating state-action history information have been described with reference to the flowcharts presented in the drawings. For a simple description, the method has been illustrated and described as a series of blocks, but the present disclosure is not limited to the sequence of the blocks, and some blocks may be performed in a sequence different from that of or simultaneously with that of other blocks, which has been illustrated and described in this specification. Various other branches, flow paths, and a sequence of blocks which achieve the same or similar results may be implemented. Furthermore, all the blocks illustrated for an implementation of the method described in this specification may not be required.

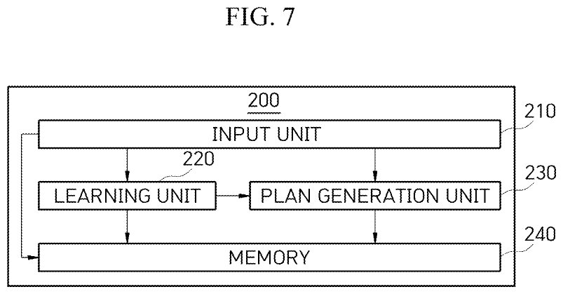

FIG. 7 is a block diagram illustrating a configuration of the multi-drone network operation plan generator 200 according to an embodiment of the present disclosure.

The multi-drone network operation plan generator 200 according to an embodiment of the present disclosure may include the input unit 210, the learning unit 220, and the plan generation unit 230, and may further include the memory 240.

The input unit 210 receives a reinforcement learning hyperparameter, delivers the reinforcement learning hyperparameter to the learning unit 220, receives multi-drone network task information, and delivers the multi-drone network task information to the plan generation unit 230. For detailed examples of the hyperparameter and detailed examples of the multi-drone network task information, reference may be made to the description related to steps S121 and step S141.

The learning unit 220 trains an actor neural network assigned to the multi-drone agent for each multi-drone agent by using the MADDPG algorithm based on the reinforcement learning hyperparameter. The learning unit 220 defines and initializes a state of the Markov game based on the defined hyperparameter, and generates observation information of each drone agent based on the state (s) of the Markov game. Furthermore, the learning unit 220 infers an action of each drone agent by using an actor neural network assigned to each drone agent, changes a state of each drone agent based on an action of each drone agent, calculates a communication cost of a corresponding multi-drone network, and calculates a reward for each drone agent through the reward model. The learning unit 220 stores <observation, action, reward, next observation> data for each drone agent in the replay buffer, extracts mini-batch data from the replay buffer through random sampling, and trains a neural network for each drone agent. The actor neural network is included in the neural network for each drone agent. The learning unit 220 calculates a policy gradient for a mini-batch with respect to each drone agent, and updates the actor neural network. Furthermore, for example, the learning unit 220 may first update a critic neural network in a way to minimize a loss function based on a mini-batch randomly sampled according to a basic algorithm of the MADDPG, may calculate a policy gradient for the mini-batch, and may update the actor neural network. The learning unit 220 repeats the aforementioned learning process up to a set upper limit of a decision step, and terminates the learning when a learning termination condition (e.g., a maximum repetition number or maximum operation time of an algorithm) is satisfied. The learning unit 220 delivers, to the plan generation unit 230, an actor neural network for each drone agent that has been finally updated. The trained actor neural network is used for the plan generation unit 230 to generate state-action history information. The learning unit 220 has been described in detail with reference to FIGS. 5A and 5B.

The plan generation unit 230 generates state-action history information by using the trained actor neural network based on multi-drone network task information, and generates a multi-drone network operation plan by post-processing (reassembling) the state-action history information.

The plan generation unit 230 generates Markov game formalization information (e.g., a state of the Markov game, the observation model, the action model, and the reward model) based on the multi-drone network task information received from the input unit 210. Furthermore, the plan generation unit 230 initializes state information of the Markov game. The plan generation unit 230 generates observation information of each drone agent based on the state information, and infers an action of each drone agent by using the trained actor neural network. The plan generation unit 230 stores, in an internal repository of the plan generation unit 230 or the memory 240, a state-action pair obtained by matching the state information and the inferred action (action information) on the basis of the same decision step. The plan generation unit 230 changes a state (s[k]) in a current step to a next state (s[k+1]) by using a known multi-drone network state transition model based on the inferred action of each drone agent. The plan generation unit 230 recursively stores the state-action pairs by repeatedly performing the aforementioned process until a task termination condition is satisfied, and generates state-action history information by synthesizing the state-action pairs stored up to a step (T) by using a value in a current step (k) in that step as a maximum decision step (T) when the task termination condition is satisfied.

Thereafter, the plan generation unit 230 generates a multi-drone network operation plan by reassembling the state-action history information for each element.

The plan generation unit 230 has been described in detail with reference to FIGS. 4 to 6.

The memory 240 stores information received from the input unit 210 or information generated by the learning unit 220 and the plan generation unit 230. For example, the memory 240 may store a set value of the reinforcement learning hyperparameter received from the input unit 210 and multi-drone network task information, and may store state information, observation information, and action information generated by the learning unit 220. Furthermore, the memory 240 may include the replay buffer necessary for reinforcement learning. Furthermore, the memory 240 may store Markov game formalization information, Markov game state information, action information, state-action history information, and a multi-drone network operation plan generated by the plan generation unit 230.

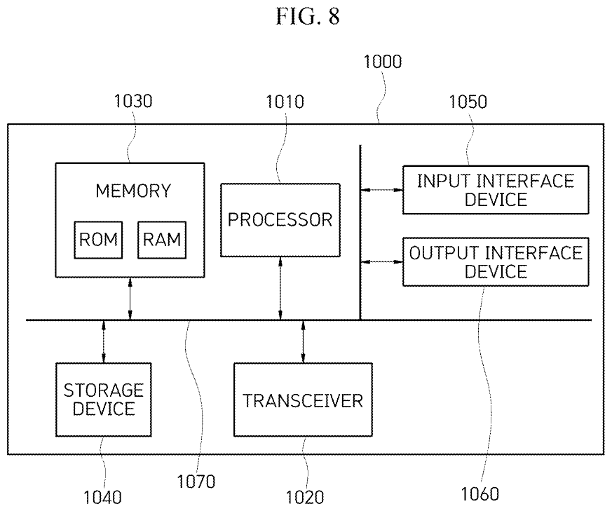

FIG. 8 is a block diagram illustrating a configuration of computer system to perform methods according to an embodiment of the present disclosure.

The computer system 1000 may include at least one processor 1010, a memory 1030 for storing at least one instruction to be executed by the processor 1010, and a transceiver 1020 performing communications through a network. The transceiver 1020 may transmit or receive a wired signal or a wireless signal.

The computer system 1000 may further include a storage device 1040, an input interface device 1050 and an output interface device 1060. The components of the computer system 1000 may be connected through a bus 1070 to communicate with each other.

The processor 1010 may execute program instructions stored in the memory 1030 and/or the storage device 1040. The processor 1010 may include a central processing unit(CPU) or a graphics processing unit(GPU), or may be implemented by another kind of dedicated processor suitable for performing the methods of the present disclosure.

The memory 1030 may load the program instructions stored in the storage device 1040 to provide to the processor 1010. The memory 1030 may include, for example, a volatile memory such as a read only memory(ROM) and a nonvolatile memory such as a random access memory(RAM).

The storage device 1040 may store the program instructions that can be loaded to the memory 1030 and executed by the processor 1010. The storage device 1040 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory(CD-ROM) and a digital video disk(DVD), magneto-optical medium such as a floptical disk, and semiconductor memories such as ROM, RAM, a flash memory, and a solid-state drive(SSD).

For reference, the components according to an embodiment of the present disclosure may be implemented in the form of software or hardware, such as a field programmable gate array (FPGA) or an application-specific integrated circuit (ASIC), and may perform given roles.

However, the “components” are not meanings limited to software or hardware, and each component may be configured to reside on an addressable storage medium and may be configured to operate one or more processors.

Accordingly, examples of the component include components, such as software components, object-oriented software components, class components, and task components, processes, functions, attributes, procedures, sub-routines, segments of a program code, drivers, firmware, a microcode, circuitry, data, a database, data structures, tables, arrays, and variables.

Components and functions provided in corresponding components may be combined into fewer components or may be further separated into additional components.

In the present disclosure, it will be understood that each block of the flowcharts and combinations of the blocks in the flowcharts may be executed by computer program instructions. These computer program instructions may be mounted on the processor of a general purpose computer, a special purpose computer, or other programmable data processing equipment, so that the instructions executed by the processor of the computer or other programmable data processing equipment create means for executing the functions specified in the flowchart block(s). These computer program instructions may also be stored in a computer-usable or computer-readable memory that can direct a computer or other programmable data processing equipment to implement a function in a particular manner, such that the instructions stored in the computer-usable or computer-readable memory produce an article of manufacture including instruction means that implement the function specified in the flowchart block(s). The computer program instructions may also be loaded on a computer or other programmable data processing equipment to cause a series of operational steps to be performed on the computer or other programmable data processing equipment to produce a computer-executed process, so that the instructions executing the computer or other programmable data processing equipment provide steps for executing the functions described in the flowchart block(s).

Furthermore, each block of the flowcharts may represent a portion of a module, a segment, or code, which includes one or more executable instructions for executing a specified logical function(s). It should also be noted that in some alternative implementations, the functions noted in the blocks may occur out of order. For example, two blocks shown in succession may in fact be executed substantially concurrently, or the blocks may sometimes be executed in the reverse order, depending upon the functionality involved.

The term “. . . unit” used in the present embodiment means software or a hardware component, such as an FPGA or an ASIC, and the “. . . unit” performs specific tasks. However, the term “. . . unit” does not mean that it is limited to software or hardware. The “. . . unit” may be configured to reside on an addressable storage medium and configured to operate one or more processors. Accordingly, examples of the “. . . unit” may include components, such as software components, object-oriented software components, class components, and task components, processes, functions, attributes, procedures, sub-routines, segments of a program code, drivers, firmware, a microcode, circuitry, data, a database, data structures, tables, arrays, and variables. The functionalities provided in the components and the “. . . units” may be combined into fewer components and “. . . units”, or may be further separated into additional components and “. . . units”. Furthermore, the components and the “. . . units” may be implemented to operate one or more CPUs within a device or a security multimedia card.

Although the present disclosure has been described with reference to the preferred embodiments, those skilled in the art may understand that the present disclosure may be modified and changed in various ways without departing from the spirit and scope of the present disclosure written in the claims.

### DESCRIPTION OF REFERENCE NUMERALS

200: multi-drone network operation plan generator
210: input unit
220: learning unit
230: plan generation unit
240: memory
1000: computer system
1010: processor
1020: transceiver
1030: memory
1040: storage device
1050: input interface device
1060: output interface device
1070: bus

What is claimed is:

1. A method of generating a multi-drone network operation plan based on reinforcement learning, the method comprising steps of:
(a) defining a reinforcement learning hyperparameter and training an actor neural network for each drone agent by using a multi-agent deep deterministic policy gradient (MADDPG) algorithm based on the defined hyperparameter;
(b) generating Markov game formalization information based on multi-drone network task information and generating state-action history information by using the trained actor neural network based on the formalization information; and
(c) generating a multi-drone network operation plan based on the state-action history information.

2. The method of claim 1, wherein the multi-drone network task information comprises information on a base station, information on a target point, information on a drone agent, information on communication, and a task termination condition.

3. The method of claim 1, wherein the step (b) comprises steps of:
(b1) generating the formalization information based on the task information;
(b2) initializing a state of each drone agent based on the formalization information;
(b3) obtaining observation for each drone agent based on the state of each drone agent;
(b4) inferring an action of each drone agent by inputting the observation to the actor neural network;
(b5) obtaining a next state of each drone agent based on the state and the action; and
(b6) determining whether a task termination condition included in the task information has been satisfied based on the next state, repeating the steps (b3) to (b5) when the task termination condition is not satisfied, and generating the state-action history information by synthesizing the state and the action when the task termination condition is satisfied.

4. The method of claim 1, wherein:
the state-action history information comprises location information of a drone for each decision step, and
the step (c) comprises generating flight path information of the drone included in the operation plan based on the location information.

5. The method of claim 1, wherein:
the state-action history information comprises a task time of a drone and location information of the drone for each decision step, and
the step (c) comprises generating speed information of the drone included in the operation plan based on the task time and the location information.

6. The method of claim 1, wherein:
the state-action history information comprises network topology history information for each decision step, and
the step (c) comprises generating topology information included in the operation plan based on the topology history information.

7. The method of claim 1, wherein:
the state-action history information comprises task intent of a drone and an action of the drone for each decision step, and
the step (c) comprises generating task execution information included in the operation plan based on the task intent and the action of the drone.

8. A multi-drone agent reinforcement learning method based on a multi-agent deep deterministic policy gradient (MADDPG) algorithm, the method comprising steps of:
(a) defining a reinforcement learning hyperparameter;
(b) initializing a state of a Markov game and obtaining observation for each drone agent based on the state of the Markov game;
(c) generating tuple data comprising observation, an action, a reward, and next observation for each drone agent by using an MADDPG algorithm based on the defined hyperparameter and the state and storing the tuple data in a replay buffer;
(d) extracting a mini-batch of the tuple data from the replay buffer through random sampling; and
(e) updating an actor neural network for each drone agent based on the mini-batch.

9. The multi-drone agent reinforcement learning method of claim 8, further comprising, after the step (e), (f) increasing a repetition number by 1, determining whether the repetition number has reached a set upper limit, and repeating the steps (c) to (e) when the repetition number does not reach the set upper limit.

10. The multi-drone agent reinforcement learning method of claim 9, further comprising, after the step (f), (g) determining whether a given learning termination condition is satisfied, terminating the learning when the given learning termination condition is satisfied, and repeating the steps (b) to (f) when the given learning termination condition is not satisfied.

11. The multi-drone agent reinforcement learning method of claim 8, wherein the step (c) comprises:
obtaining the observation based on the state,
inferring the action based on the observation,
obtaining the reward and a next state of each drone agent based on the state and the action, and
obtaining the next observation based on the next state.

12. The multi-drone agent reinforcement learning method of claim 8, wherein:
the hyperparameter comprises a parameter for the actor neural network, and
the step (c) comprises inferring the action by using the actor neural network.

13. The multi-drone agent reinforcement learning method of claim 8, wherein:
the hyperparameter comprises a topology model and a communication cost model about a communication network of a multi-drone, and
the step (c) comprises calculating a communication cost of the communication network by using the topology model and the communication cost model based on the state and the action and calculating the reward based on the state, the action, and the communication cost.

14. The multi-drone agent reinforcement learning method of claim 8, wherein the state comprises a task time, a location vector for each drone agent, a multi-drone communication network topology, connectivity of a multi-drone communication network, and whether a task for each drone agent has been completed.

15. The multi-drone agent reinforcement learning method of claim 8, wherein:
the observation comprises a current task time, a location of a drone agent, current task intent of a drone agent, communication network connectivity of a multi-drone, relative location coordinates of a ground station, relative location coordinates of a target point, whether a drone agent has been completed a task, and relative location coordinates of another drone agent, and
the task intent is any one of communication relay between other drone agents, execution of a task by the drone agent, moving in a direction in which another drone agent is present, and moving in a direction toward the ground station.

16. The multi-drone agent reinforcement learning method of claim 8, wherein the reward is defined based on connectivity of a multi-drone communication network, a communication cost of the network, and whether a task for each drone agent has been completed.

17. The multi-drone agent reinforcement learning method of claim 8, wherein:
the drone agent has one piece of task intent every decision step,
the action corresponds to any one of a simple moving direction decision action and an intent-explicit decision action,
the simple moving direction decision action is an action of determining only a moving direction without changing current task intent in a next decision step,
the intent-explicit decision action is an action of explicitly selecting task intent in a next decision step, and
the task intent is any one of communication relay between other drone agents, execution of a task by a drone agent, moving in a direction in which another drone agent is present, and moving in a direction toward a ground station.

18. A multi-drone network operation plan generator based on reinforcement learning, comprising:
an input unit configured to receive a reinforcement learning hyperparameter and multi-drone network task information;
a learning unit configured to train an actor neural network for each drone agent by using a multi-agent deep deterministic policy gradient (MADDPG) algorithm based on the reinforcement learning hyperparameter; and
a plan generation unit configured to generate state-action history information by using the trained actor neural network based on the multi-drone network task information and generate a multi-drone network operation plan based on the state-action history information.

19. The multi-drone network operation plan generator of claim 18, wherein the learning unit
generates tuple data comprising observation, an action, a reward, and next observation for each drone agent by using the MADDPG algorithm based on the reinforcement learning hyperparameter, and
trains the actor neural network for each drone agent based on a mini-batch of the tuple data.

20. The multi-drone network operation plan generator of claim 18, wherein the plan generation unit
initializes a state of each drone agent based on the task information,
obtains observation for each drone agent based on the initialized state,
infers an action of each drone agent by inputting the observation to the trained actor neural network,
changes the state of each drone agent based on the state and the action, and
determines whether a task termination condition included in the task information is satisfied based on the state and generates the state-action history information by synthesizing histories of the state and the action when determining that the task termination condition is satisfied.
